(19) United States
(12) Patent Application Publication
(10) Pub. No.: US 2026/0308785 A1
(43) Pub. Date: Oct. 8, 2026

(54) ELECTRODE COMPOSITION FOR PROTON EXCHANGE MEMBRANE WATER ELECTROLYSIS, ELECTRODE FOR PROTON EXCHANGE MEMBRANE WATER ELECTROLYSIS, ANODE, MEMBRANE-ELECTRODE ASSEMBLY, AND PROTON EXCHANGE MEMBRANE WATER ELECTROLYSIS CELL

(71) Applicants: Hyundai Motor Company, Seoul (KR); Kia Corporation, Seoul (KR)

(72) Inventors: Jihan Park, Hwaseong (KR); Shin Jang, Hwaseong (KR)

(21) Appl. No.: 19/305,028

(22) Filed: Aug. 20, 2025

(30) Foreign Application Priority Data
Apr. 2, 2025 (KR) 10-2025-0042665

(51) Int. Cl. C25B 11/081; C25B 1/04; C25B 9/23; C25B 11/031; C25B 11/065

(52) U.S. Cl. CPC C25B 11/081; C25B 1/04; C25B 9/23; C25B 11/031; C25B 11/065

(57) ABSTRACT

Provided is an electrode composition for proton exchange membrane water electrolysis comprising a binder, a catalyst, and a solvent, wherein the binder comprises a polar group-free binder. The electrode may comprise a binder, a catalyst, and a solvent, wherein the binder may comprise a polar group-free binder. The binder may further comprise a polar group-containing binder. Also provided is an anode comprising the electrode composition for proton exchange membrane water electrolysis. Also provided is a membrane-electrode assembly comprising the electrode for proton exchange membrane water electrolysis. Also provided is a proton exchange membrane water electrolysis cell comprising the electrode for proton exchange membrane water electrolysis.

### CROSS-REFERENCE TO RELATED APPLICATION

This present application claims under 35 U.S.C. § 119 (a) the benefit of Korean Patent Application No. 10-2025-0042665, filed on Apr. 2, 2025, in the Korean Intellectual Property Office, the entire disclosure of which is incorporated herein by reference.

### BACKGROUND

### Technical Field

The present disclosure relates to an electrode composition for proton exchange membrane water electrolysis, an electrode for proton exchange membrane water electrolysis, an anode, a membrane-electrode assembly, and a proton exchange membrane water electrolysis cell.

### Background

A proton exchange membrane water electrolysis (PEMWE) cell is an electrochemical conversion device that uses electricity to decompose water (H₂O) into hydrogen (H₂) and oxygen (O₂).

Since water is continuously supplied to the anode of the PEMWE cell, it is vulnerable to swelling or structural changes caused by water, which may lead to deterioration of anode robustness and overall durability of the PEMWE cell.

The matters described in this Background section are provided solely to enhance understanding of the background of the disclosure, and should not be taken as acknowledgement that they correspond to existing technologies already known to those skilled in the art.

### SUMMARY

The following summary presents a simplified summary of certain features. The summary is not an extensive overview and is not intended to identify key or critical elements.

Embodiments of the present disclosure may provide an electrode composition for proton exchange membrane water electrolysis, an electrode for proton exchange membrane water electrolysis, an anode, a membrane-electrode assembly, and a proton exchange membrane water electrolysis cell capable of preventing swelling or structural changes caused by water.

Embodiments of the present disclosure may provide an electrode composition for proton exchange membrane water electrolysis, an electrode for proton exchange membrane water electrolysis, an anode, a membrane-electrode assembly, and a proton exchange membrane water electrolysis cell capable of securing electrochemical performance.

According to some embodiments of the present disclosure, an electrode composition for proton exchange membrane water electrolysis may include a binder, a catalyst, and a solvent, wherein the binder may include a polar group-free binder.

In some embodiments, the binder is present in an amount of greater than about 0 wt % and less than about 4.5 wt % based on the total weight of the electrode composition.

In some embodiments, the binder may be present in an amount of about 5 wt % to 40 wt % based on the total solid content of the electrode composition.

In some embodiments, the binder may include one or more of poly(1,1,2,2-tetrafluoroethylene) (PTFE), polyetheretherketone (PEEK), polyimide (PI), polybenzimidazole (PBI), or any combination thereof.

In some embodiments, the solvent may include an alcohol, and the alcohol is present in an amount of 60 wt % to 90 wt % based on the total weight of the solvent.

In some embodiments, the binder may further include a polar group-containing binder.

In some embodiments, based on the total weight of the binder, the polar group-free binder may be present in an amount greater than or equal to about 30 wt % and less than about 90 wt %.

In some embodiments, the polar group-free binder may be present in an amount of greater than about 0 wt % and less than about 4.5 wt % based on the total weight of the electrode composition.

The polar group-free binder may comprises one or more of poly(1,1,2,2-tetrafluoroethylene) (PTFE), polyetheretherketone (PEEK), polyimide (PI), polybenzimidazole (PBI), or any combination thereof.

In some embodiments, the polar group-containing binder may comprise perfluorosulfonic acid (PFSA).

According to some embodiments of the present disclosure, an electrode for proton exchange membrane water electrolysis may include a binder and a catalyst, wherein the binder may include a polar group-free binder.

In some embodiments, the binder may be present in an amount of about 5 wt % to 40 wt % based on the total weight of the electrode.

In some embodiments, the D10 of the binder may be about 0.5 μm to 2.0 μm, the D50 is about 2.5 μm to 5 μm, and the D90 is about 20 μm to 80 μm.

In some embodiments, the binder may include one or more of poly(1,1,2,2-tetrafluoroethylene) (PTFE), polyetheretherketone (PEEK), polyimide (PI), polybenzimidazole (PBI), or any combination thereof.

In some embodiments, the binder may further include a polar group-containing binder.

In some embodiments, based on the total weight of the binder, the polar group-free binder may be present in an amount of greater than or equal to about 30 wt % and less than about 90 wt %.

In some embodiments, the polar group-free binder may comprise one or more of poly(1,1,2,2-tetrafluoroethylene) (PTFE), polyetheretherketone (PEEK), polyimide (PI), polybenzimidazole (PBI), or any combination thereof and the polar group-containing binder comprises perfluorosulfonic acid (PFSA).

According to some embodiments of the present disclosure, an anode may include the electrode composition for proton exchange membrane water electrolysis.

According to some embodiments of the present disclosure, a membrane-electrode assembly may include the electrode for proton exchange membrane water electrolysis.

According to some embodiments of the present disclosure, a proton exchange membrane water electrolysis cell may include the electrode for proton exchange membrane water electrolysis.

As discussed, the method and system suitably include use of a controller or processer.

In another embodiment, vehicles are provided that comprise an apparatus as disclosed herein.

When the electrode composition and/or electrode for proton exchange membrane water electrolysis according to various embodiments of the present disclosure are applied as an anode of a PEMWE cell, swelling or structural changes caused by water may be prevented. Therefore, the robustness of the anode may be enhanced to improve the overall durability of the PEMWE cell. Furthermore, electrochemical performance of the PEMWE cell may be secured, and improved initial performance and degradation rate may be achieved.

The effects of the present disclosure are not limited to those mentioned above, and other effects not mentioned can be clearly understood by those skilled in the art from the following description.

### BRIEF DESCRIPTION OF THE DRAWINGS

The foregoing and other aspects, as well as the following detailed description of the embodiments, should be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is a cross-sectional view of a proton exchange membrane water electrolysis (PEMWE) cell according to various embodiments of the present disclosure.

FIG. 2 shows IV curve measurement results of electrochemical performance (efficiency) of PEMWE cells applying the electrode compositions of Example 1 and Comparative Example 1.

FIG. 3 shows constant current evaluation results at 2 A/cm² of PEMWE cells applying the electrode compositions of Example 1 and Comparative Example 1.

### DETAILED DESCRIPTION

Embodiments described in the present disclosure may be modified into various other forms, and the technology according to exemplary embodiments is not limited to the embodiments described below. The exemplary embodiments are provided to make the description of the present disclosure thorough and to fully convey the scope of the present disclosure to those skilled in the art.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

In addition, numerical ranges used in this specification include all values within the range between lower and upper limits, all increments logically derived from the form and width of the defined range, all values limited therein, and all possible combinations of upper and lower limits of numerical ranges defined in different forms. Unless specifically defined in the present disclosure, values outside the defined numerical ranges that may occur due to experimental error or rounding off of values are also included within the defined numerical ranges.

Furthermore, terms including ordinals such as first, second, etc. may be used to describe various elements, but the elements are not limited by these terms. These terms are only used to distinguish one constituent element from another.

In the present disclosure, D10, D50, and D90 refer to particle sizes corresponding to cumulative volume fractions of 10%, 50%, and 90%, respectively. The average particle size can be derived from particle size distribution results analyzed using MICROTRAC's S3500 by sampling the particles to be measured according to ISO 13320-1 standard.

The term “polar group-free binder” herein refers to a binder material that at least substantially lacks functional groups imparting polarity. In aspects, the term “polar group-free binder” refers to a binder material with relatively fewer polar groups compared to a “polar group-containing binder”. For example, in aspects, a polar group-free binder will have up to or less than 30, 25, 20, 15, 10, 9, 8, 7, 6, 5, 4, 3, 2 or 1 percent of the molecular mass of the binder comprises polar groups. In aspects, a polar group-free binder polar will not contain any polar groups. A polar group as referred to herein includes those groups that have an electronegativity of at least 0.3 or 0.4 in a bond between two atoms in the group, such as nitro; alcohol; carbonyl; carboxylate (including esters); sulfonyl; sulfide; amide; imine; Michael acceptors; halide-substituted groups such as fluoroalkyl, bromoalkyl, chloroalkyl and iodoalkyl; the like.

The term “polar group-containing binder” herein refers to a binder material that includes one or more functional groups imparting polarity. In aspects, the term “polar group-containing binder” refers to a binder material with relatively more polar groups compared to a “polar group-free binder”. For example, in aspects, a polar group-containing suitably may have up to or greater than 5, 6, 7, 8, 10, 15, 20, 25 or 30 percent of the molecular mass of the binder comprises polar groups. In aspects, a polar group-containing binder may contain one or more repeat units that contain one or more polar groups. Again, a polar group as referred to herein includes those groups that have an electronegativity of at least 0.3 or 0.4 in a bond between two atoms in the group, such as nitro; alcohol; carbonyl; carboxylate (including esters); sulfonyl; sulfide; amide; imine; Michael acceptors; halide-substituted groups such as fluoroalkyl, bromoalkyl, chloroalkyl and iodoalkyl; the like.

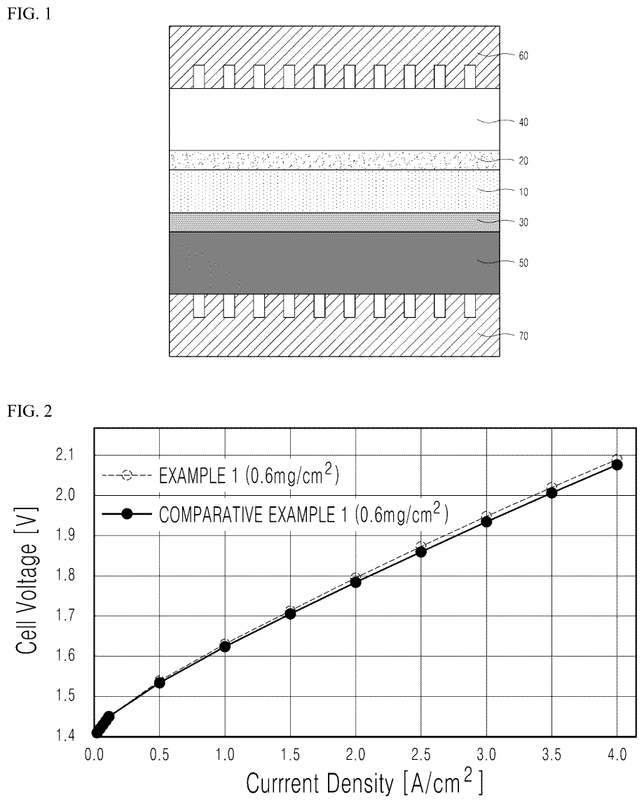

Referring to FIG. 1, a proton exchange membrane water electrolysis (PEMWE) cell includes a membrane-electrode assembly (MEA) comprising an electrolyte membrane (10), an anode (20), and a cathode (30), a porous transport layer (PTL) (40) for the anode, a gas diffusion layer (GDL) (50) for the cathode, an anode bipolar plate (60), and a cathode bipolar plate (70). Water is supplied to the anode (20) through the anode PTL (40) via channels in the anode bipolar plate (60), and hydrogen gas generated at the cathode (30) is discharged through the cathode GDL (50) and channels in the cathode bipolar plate (70). In the electrochemical reaction of such a PEMWE cell, water supplied to the anode (20) is separated into oxygen gas (O₂), hydrogen ions (H⁺), and electrons by oxygen evolution reaction (OER), after which they move to the cathode (30) through the electrolyte membrane (10) and external circuit, respectively, and generate hydrogen gas by hydrogen evolution reaction (HER).

Since water is continuously supplied to the anode (20) of the PEMWE cell, the anode (20) is vulnerable to swelling or structural changes caused by water, which may lead to deterioration of anode robustness and overall durability of the PEMWE cell.

When applied to the anode, an electrode composition for proton exchange membrane water electrolysis according to various embodiments of the present disclosure may prevent swelling or structural changes caused by water. Therefore, the robustness of the anode may be enhanced to improve the overall durability of the PEMWE cell.

For this purpose, the electrode composition for proton exchange membrane water electrolysis according to various embodiments of the present disclosure may include a binder, a catalyst, and a solvent, wherein the binder may include a polar group-free binder.

The binder serves to bind the catalyst. The binder may bind catalyst materials to enhance the robustness of the anode. The binder may be a binder without moisture absorption characteristics. The binder may not function to transfer hydrogen ions (H⁺) generated in the anode.

The binder may include a polar group-free binder. For example, the binder may include one or more of poly(1,1,2,2-tetrafluoroethylene) (PTFE), polyetheretherketone (PEEK), polyimide (PI), polybenzimidazole (PBI), or any combination thereof.

The polar group-free binder has no moisture absorption properties, thereby preventing swelling due to moisture changes in the operating environment of the anode in the PEMWE cell. Accordingly, the durability of the anode may be improved. Furthermore, since water is always present in the anode of the PEMWE cell, hydrogen ions (H⁺) generated in the anode may be transferred through water, and there is no need to transfer ions through the binder.

The binder may be present in an amount of greater than 0 wt % and less than 4.5 wt % based on the total weight of the electrode composition. The binder may be present in an amount of 1.5 wt % to 4.5 wt %, or 2.0 wt % to 3.0 wt % based on the total weight of the electrode composition. By satisfying the aforementioned range of binder content, dispersibility of the electrode composition and structural stability of the electrode may be secured.

The binder may include only the polar group-free binder. The polar group-free binder may be present in an amount of greater than 0 wt % and less than 4.5 wt %. The binder may be present in an amount of 1.5 wt % to 3.5 wt %, or 2.0 wt % to 3.0 wt % based on the total weight of the electrode composition. By satisfying the aforementioned range of polar group-free binder content, dispersibility of the electrode composition and structural stability of the electrode may be secured.

The binder may be present in an amount of 5 wt % to 40 wt % based on the total solid content of the electrode composition. Here, the solid content includes the binder and the catalyst. The binder may be present in an amount of 5 wt % to 30 wt %, or 5 wt % to less than 20 wt %, or 8 wt % to less than 20 wt %, or 8 wt % to 13 wt %, based on the total solid content of the electrode composition. By satisfying the aforementioned range of binder content, dispersibility of the electrode composition and binding force of the electrode may be secured.

The binder may include only the polar group-free binder. The polar group-free binder may be present in an amount of 5 wt % to 40 wt % based on the total solid content of the electrode composition. Here, the solid content includes the polar group-free binder and the catalyst. The polar group-free binder may be present in an amount of 8 wt % to 30 wt %, or 8 wt % to 20 wt %, or 8 wt % to 15 wt %, or 8 wt % to 13 wt % based on the total solid content of the electrode composition. By satisfying the aforementioned range of polar group-free binder content, dispersibility of the electrode composition and binding force of the electrode may be secured.

The D10 of the binder may be 0.5 μm to 2.0 μm. The D10 of the binder may be 0.8 μm to 1.5 μm, or 1.0 μm to 1.4 μm.

The D50 of the binder may be 2.5 μm to 5 μm. The D50 of the binder may be 3.0 μm to 4.7 μm, or 3.5 μm to 4.5 μm.

The D90 of the binder may be 20 μm to 80 μm. The D90 of the binder may be 30 μm to 70 μm, or 40 μm to 70 μm, or 45 μm to 65 μm, or 50 μm to 60 μm.

By satisfying the aforementioned range of binder diameter, dispersibility of the electrode composition and binding force of the electrode can be secured.

The catalyst may include one or more selected from the group consisting of iridium (Ir), ruthenium (Ru), metal materials containing iridium (Ir), metal materials containing ruthenium (Ru), oxides containing iridium (Ir), oxides containing ruthenium (Ru), oxides containing a mixture of iridium (Ir) and ruthenium (Ru), and a mixture of iridium (Ir) and ruthenium (Ru).

The solid content may be present in an amount of 15 wt % to 35 wt % based on the total weight of the electrode composition. That is, the binder and catalyst may be present in an amount of 15 wt % to 35 wt % based on the total weight of the electrode composition. The binder and catalyst may be present in an amount of 20 wt % to 30 wt % based on the total weight of the electrode composition. By satisfying the aforementioned range of solid content, dispersibility of the binder and catalyst may be secured to form a homogeneous anode, and viscosity and coating quality may be secured.

The solvent may include an organic solvent and water. The organic solvent may be an alcohol. The alcohol may include one or more of methanol, ethanol, 1-propanol, isopropyl alcohol, n-propanol, butanol, isobutanol, 2-butanol, tert-butanol, n-pentanol, isopentyl alcohol, 2-methyl-1-butanol, neopentyl alcohol, diethyl carbinol, methyl propyl carbinol, methyl isopropyl carbinol, dimethyl ethyl carbinol, 1-hexanol, 2-hexanol, 3-hexanol, 2-methyl-1-pentanol, 3-methyl-1-pentanol, 4-methyl-1-pentanol, 2-methyl-2-pentanol, 3-methyl-2-pentanol, 4-methyl-2-pentanol, 2-methyl-3-pentanol, 3-methyl-3-pentanol, 2,2-dimethyl-1-butanol, 2,3-dimethyl-1-butanol, 2,3-dimethyl-2-butanol, 3,3-dimethyl-1-butanol, 2-ethyl-1-butanol, 1-heptanol, 2-heptanol, 3-heptanol, 4-heptanol or any combination thereof.

The alcohol may be present in an amount of 60 wt % to 90 wt % based on the total weight of the solvent. The alcohol may be present in an amount of 65 wt % to 80 wt %, or 65 wt % to 75 wt % based on the total weight of the solvent. By satisfying the aforementioned range of alcohol content, fire hazards during preparation of the electrode composition may be prevented, and dispersibility of the electrode composition may be secured.

When the electrode composition for proton exchange membrane water electrolysis according to some embodiments is applied as the anode of a PEMWE cell, swelling or structural changes caused by water may be prevented. Accordingly, the robustness of the anode may be enhanced to improve the overall durability of the PEMWE cell. Furthermore, electrochemical performance of the PEMWE cell may be secured, and improved initial performance and degradation rate may be achieved.

Hereinafter, an electrode composition for proton exchange membrane water electrolysis according to another embodiment of the present disclosure will be described. Description may be omitted for configurations identical or similar to those previously explained.

The electrode composition for proton exchange membrane water electrolysis according to this embodiment of the present disclosure may include two or more types of binders as the binder. The electrode composition for proton exchange membrane water electrolysis according to this embodiment of the present disclosure may include a first binder which is a polar group-free binder, and a second binder which is a polar group-containing binder.

The first binder serves to bind the catalyst. The first binder may bind catalyst materials to enhance the robustness of the anode. The first binder may be a binder without moisture absorption characteristics. The first binder may not function to transfer hydrogen ions (H⁺) generated in the anode. The first binder may complement the second binder having moisture absorption characteristics to prevent structural changes of the anode.

The first binder, as a polar group-free binder, may include one or more of poly(1,1,2,2-tetrafluoroethylene) (PTFE), polyetheretherketone (PEEK), polyimide (PI), polybenzimidazole (PBI), or any combination thereof.

The second binder serves to bind the catalyst. The second binder may transfer hydrogen ions (H⁺) generated in the anode. The second binder may have moisture absorption characteristics.

The second binder, as a polar group-containing binder, may include perfluorosulfonic acid (PFSA).

The first binder may be present in an amount of greater than 30 wt % and less than 90 wt % based on the total weight of the binder. The first binder may be present in an amount of 40 wt % to 85 wt %, or 50 wt % to 80 wt %, based on the total weight of the binder. By satisfying the aforementioned range of first binder content, dispersibility of the electrode composition and structural stability of the electrode may be secured.

The first binder may be present in an amount of greater than 0 wt % and less than 4.5 wt % based on the total weight of the electrode composition. The first binder may be present in an amount of 1.5 wt % to 4.5 wt %, or 2.5 wt % to 4.0 wt %, based on the total weight of the electrode composition. By satisfying the aforementioned range of first binder content, dispersibility of the electrode composition and structural stability of the electrode may be secured.

The D10 of the first binder may be 0.5 μm to 2.0 μm. The D10 of the first binder may be 0.5 μm to 1.5 μm, or 1.0 μm to 1.4 μm.

The D50 of the first binder may be 2.5 μm to 5 μm. The D50 of the first binder may be 3.0 μm to 4.7 μm, or 3.3 μm to 4.7 μm.

The D90 of the first binder may be 20 μm to 80 μm. The D90 of the first binder may be 20μ m to 75 μm, or 22 μm to 72 μm, or 23 μm to 72μ m.

By satisfying the aforementioned ranges of first binder diameter, dispersibility of the electrode composition and binding force of the electrode may be secured.

The first binder and the second binder may be present in an amount of 5 wt % to 40 wt % based on the total solid content of the electrode composition. Here, the solid content includes the first binder, the second binder, and the catalyst. The first binder and the second binder may be present in an amount of 10 wt % to 30 wt %, or 15 wt % to 25 wt % based on the total solid content of the electrode composition. By satisfying the aforementioned range of first binder and second binder content, dispersibility of the electrode composition and binding force of the electrode may be secured.

When the electrode composition for proton exchange membrane water electrolysis according to various embodiments of the present disclosure is applied as the anode of a PEMWE cell, swelling or structural changes caused by water may be prevented. Accordingly, the robustness of the anode may be enhanced to improve the overall durability of the PEMWE cell. Furthermore, electrochemical performance of the PEMWE cell may be secured, and improved initial performance and degradation rate may be achieved.

Hereinafter, an electrode for proton exchange membrane water electrolysis according to another embodiment of the present disclosure will be described. Description may be omitted for configurations identical or similar to those previously explained.

The electrode for proton exchange membrane water electrolysis according to various embodiments of the present disclosure may include the aforementioned electrode composition. The electrode for proton exchange membrane water electrolysis according to the present disclosure may be manufactured from the aforementioned electrode composition.

The electrode for proton exchange membrane water electrolysis according to the present disclosure may include a binder and a catalyst, wherein the binder may include a polar group-free binder.

The binder may be present in an amount of 5 wt % to 40 wt % based on the total weight of the electrode. The binder may be present in an amount of 5 wt % to 30 wt %, 5 wt % to less than 20 wt %, 8 wt % to less than 20 wt %, or 8 wt % to 13 wt %, based on the total weight of the electrode. By satisfying the aforementioned range of binder content, the binding force of the electrode may be secured.

The binder may include only the polar group-free binder. The polar group-free binder may be present in an amount of 5 wt % to 40 wt % based on the total weight of the electrode. The polar group-free binder may be present in an amount of 8 wt % to 30 wt %, 8 wt % to 20 wt %, 8 wt % to 15 wt %, or 8 wt % to 13 wt %, based on the total weight of the electrode. By satisfying the aforementioned range of polar group-free binder content, a binding force of the electrode may be secured.

An electrode for proton exchange membrane water electrolysis according to another embodiment of the present disclosure may include two or more types of binders as the binder. The electrode for proton exchange membrane water electrolysis according to this embodiment of the present disclosure may include a first binder which is a polar group-free binder, and a second binder which is a polar group-containing binder.

The first binder serves to bind the catalyst. The first binder may bind catalyst materials to enhance the robustness of the electrode. The first binder may be a binder without moisture absorption characteristics. The first binder may not function to transfer hydrogen ions (H+) generated in the electrode. The first binder may complement the second binder having moisture absorption characteristics to prevent structural changes of the anode.

The first binder, as a polar group-free binder, may include one or more of poly(1,1,2,2-tetrafluoroethylene) (PTFE), polyetheretherketone (PEEK), polyimide (PI), polybenzimidazole (PBI), or any combination thereof.

The second binder serves to bind the catalyst. The second binder may transfer hydrogen ions (H+) generated in the electrode. The second binder may have moisture absorption characteristics.

The second binder, as a polar group-containing binder, may include perfluorosulfonic acid (PFSA).

The first binder may be present in an amount of greater than 0 wt % and less than 4.5 wt % based on the total weight of the electrode. The first binder may be present in an amount of 1.5 wt % to 4.5 wt %, or 2.5 wt % to 4.0 wt %, based on the total weight of the electrode. By satisfying the aforementioned range of first binder content, structural stability of the electrode may be secured.

The first binder and the second binder may be present in an amount of 5 wt % to 40 wt % based on the total weight of the electrode. The first binder and the second binder may be present in an amount of 10 wt % to 30 wt %, or 15 wt % to 25 wt %, based on the total weight of the electrode. By satisfying the aforementioned range of first binder and second binder content, the binding force of the electrode may be secured.

An anode according to various embodiments of the present disclosure may include the aforementioned electrode composition. A membrane-electrode assembly (MEA) according to various embodiments of the present disclosure may include the aforementioned electrode. A proton exchange membrane water electrolysis (PEMWE) cell according to various embodiments of the present disclosure may include the aforementioned electrode.

Hereinafter, embodiments of the present disclosure will be further described with reference to specific experimental examples. The examples and comparative examples included in the experimental examples are merely illustrative of the present disclosure and do not limit the appended claims, and it is apparent to those skilled in the art that various changes and modifications of the examples are possible within the scope and technical spirit of the present disclosure, and such variations and modifications are also naturally included in the scope of the appended claims.

### Experimental Example 1: Verification of Electrochemical Performance

Poly(1,1,2,2-tetrafluoroethylene) (PTFE) was prepared as the first binder, which is a polar group-free binder. Perfluorosulfonic acid (PFSA) was prepared as the second binder, which is a polar group-containing binder. An iridium (Ir) catalyst was prepared as the catalyst, and isopropyl alcohol (IPA) and water were prepared as the solvent.

An electrode composition having compositions of binder, catalyst, organic solvent, and water as shown in Table 1 below was mechanically dispersed. The composition was coated on a polyethylene naphthalate (PEN) release film by slot die coating, and the solvent was evaporated to prepare an anode electrode.

Here, a composition using only PTFE as the binder was prepared as Example 1, and a composition using only PFSA as the binder was prepared as Comparative Example 1. The amount of binder loaded was the same at 0.6 mg/cm².

TABLE 1

| | | | Solvent | |
|---|---|---|---|---|
| | Solid Content¹⁾ | | Organic | |
| | Binder²⁾ | Catalyst | Solvent³⁾ | Water |
| | 2.5 wt % | 22.5 wt % | 52.5 wt % | 22.5 wt % |
| | 25 wt % | | 75 wt % | |
| Composition | 100 wt % | | | |
| Total | | | | |

¹⁾Solid content based on total composition: 25 wt %
²⁾Binder content based on total solid content: 10 wt %
³⁾Organic solvent content based on total solvent: 70 wt %

Meanwhile, a membrane-electrode assembly was fabricated by applying Pt/C catalyst as a cathode electrode and Nafion 115 (Nafion material, DuPont) as an electrolyte membrane. Subsequently, electrochemical performance (efficiency) was evaluated by the IV curve.

FIG. 2 shows IV curve measurement results of electrochemical performance (efficiency) of PEMWE cells applying the electrode compositions of Example 1 and Comparative Example 1.

Referring to FIG. 2, it can be seen that Example 1, which used only PTFE as the binder, exhibited performance equivalent to that of Comparative Example 1, which used only PFSA as the binder. Accordingly, it was confirmed that, in a PEMWE cell, the polar group-containing binder in the anode can be completely replaced with a polar group-free binder.

### Experimental Example 2: Verification of Initial Degradation Rate

For durability evaluation of the membrane-electrode assembly, the difference in initial degradation rate was compared for PEMWE cells applied with the electrode compositions of Example 1 and Comparative Example 1 according to the above Experimental Example 1.

For durability evaluation of the membrane-electrode assembly in the PEMWE cell, it was operated in constant current mode. In constant current evaluation, the trend typically differs between the initial evaluation period (0-300 hr) and the later evaluation period (after 300 hr), mainly showing a pattern of rapid degradation (voltage increase) during the initial evaluation period followed by stabilization during the later evaluation period. Therefore, the overall durability can be represented by the degradation rate during the initial evaluation period.

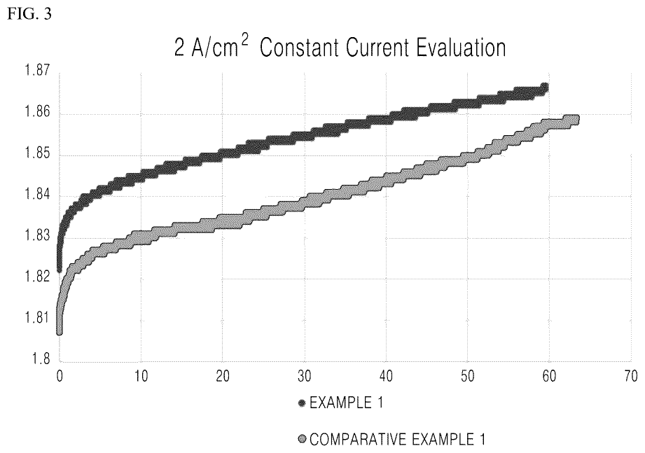

FIG. 3 shows constant current evaluation results at 2 A/cm² of PEMWE cells applying the electrode compositions of Example 1 and Comparative Example 1. The x-axis represents time (hr), and the y-axis represents cell voltage (V).

Referring to FIG. 3, it was confirmed that Example 1 using only PTFE as the binder showed superior initial degradation rate compared to Comparative Example 1 using only PFSA. That is, it can be seen that Example 1 using only PTFE as the binder has superior structural stability.

The degradation rates and initial performances of Example 1 and Comparative Example 1 are summarized in Table 2 below.

TABLE 2

| | Example 1 | Comparative Example 1 |
|---|---|---|
| Degradation rate (μV/h) | 547 | 476 |
| Initial performance (V) | 1.822 | 1.807 |

Referring to Table 2 above, in terms of initial performance, Comparative Example 1 was superior by 15 mV, but this was within the margin of error.

### Experimental Example 3: Evaluation of Electrode Manufacturability and Swelling Rate According to Electrode Composition and Binder Particle Size

Poly(1,1,2,2-tetrafluoroethylene) (PTFE) was prepared as the first binder, which is a polar group-free binder. Perfluorosulfonic acid (PFSA) was prepared as the second binder, which is a polar group-containing binder. An iridium (Ir) catalyst was prepared as the catalyst, and isopropyl alcohol (IPA) and water were prepared as the solvent.

After mechanical dispersion of the electrode composition shown in Table 3 below, the composition was coated onto a PEN release film using slot die coating to manufacture an anode electrode. At this time, the solid content (first binder+second binder+catalyst) was fixed at 25 wt % based on the total weight of the composition, and the organic solvent content was fixed at 70 wt % based on the total weight of the solvent.

The electrode manufacturability and swelling rate according to the electrode composition and binder particle size shown in Table 3 below were evaluated.

TABLE 3

| | Binder | First | First | | | |
|---|---|---|---|---|---|---|
| | content | binder | binder | | | |
| | based | content | content | | | |
| | on | based | based | | | |
| | total | on | on | Particle size | | |
| | solid | total | total | (μm) | | Swelling |
| | content | binder | composition | (D10/D50/D90) | Manufacturability | rate (%) |
| Comparative | 20 | 0 | 0 | 1.04 / 2.98 / | ◯ | 20.6 |
| Example 2 | wt % | wt % | wt % | 7.54 | | |
| Example 1 | 10 | 100 | 2.5 | 1.24 / 4.30 / | ◯ | 0.5 |
| | wt % | wt % | wt % | 55.87 | | |
| Example 2 | 20 | 50 | 2.5 | 1.09 / 3.57 / | ◯ | 1.8 |
| | wt % | wt % | wt % | 25.97 | | |
| Example 3 | 20 | 70 | 3.5 | 1.16 / 3.89 / | ◯ | 1.6 |
| | wt % | wt % | wt % | 36.71 | | |
| Example 4 | 20 | 80 | 4.0 | 1.32 / 4.68 / | ◯ | 1.4 |
| | wt % | wt % | wt % | 70.21 | | |
| Comparative | 20 | 90 | 4.5 | 2.24 / 251.6 / | X | — |
| Example 3 | wt % | wt % | wt % | 417.3 | | |
| Comparative | 20 | 100 | 5.0 | 2.47 / 364.5 / | X | — |
| Example 4 | wt % | wt % | wt % | 515 | | |
| Comparative | 20 | 30 | 1.5 | 1.02 / 3.67 / | ◯ | 15.9 |
| Example 5 | wt % | wt % | wt % | 21.9 | | |
| Comparative | 20 | 20 | 1.0 | 0.99 / 3.35 / | ◯ | 16.6 |
| Example 6 | wt % | wt % | wt % | 19.64 | | |
| Comparative | 20 | 10 | 0.5 | 0.97 / 3.29 / | ◯ | 18.4 |
| Example 7 | wt % | wt % | wt % | 16.76 | | |

### (1) Electrode Manufacturability Evaluation

Thickness was measured at 5 points selected at regular intervals along the length direction of the electrode, and then the difference between the maximum thickness value and the minimum thickness value compared to the average thickness was calculated. By checking thickness uniformity, coating quality and electrode manufacturability were evaluated as follows:

$$O : ( ( Maximum thickness - Minimum thickness ) / Average thickness ) * 100 < 10 \%$$

$$X : ( ( Maximum thickness - Minimum thickness ) / Average thickness ) * 100 \geq 10 \%$$

### (2) Electrode Swelling Rate Evaluation

The swelling rate was evaluated by measuring the thickness change after 48 hours of immersing a film sample, made using only binder without catalyst, completely in distilled water.

Referring to Table 3 above, in Comparative Examples 3 and 4, where the content of the first binder based on the total weight of the composition was 4.5 wt % or more, it was confirmed that the dispersibility of the composition decreased, resulting in deteriorated coating quality and difficulty in manufacturing electrodes with uniform thickness. Accordingly, it was confirmed that the optimal mixing amount of the first binder based on the total weight of the composition is less than 4.5 wt %.

In particular, Comparative Examples 3 and 4 had binder particle sizes with D10 exceeding 2.0 μm, D50 exceeding 5 μm, and D90 exceeding 80 μm, resulting in decreased dispersibility of the composition, deteriorated coating quality, and difficulty in manufacturing electrodes with uniform thickness.

Referring to Example 1 and Comparative Example 4, when only the first binder was included as the binder and the binder content was 20 wt % based on the total solid content, it was confirmed that the electrode manufacturability decreased. Therefore, when only the first binder is included as the binder, it can be seen that the binder content should be included at less than 20 wt % based on the total solid content.

Referring to Examples 2, 3, 4 and Comparative Example 3, when both the first binder and the second binder were included as the binder and the content of the first binder was 90 wt % based on the total weight of the binder, it was confirmed that electrode manufacturability decreased. Therefore, when both the first binder and the second binder are included as the binder, it can be seen that the content of the first binder should be included at less than 90 wt % based on the total weight of the binder.

Regarding electrode swelling rate, in Examples 1 to 4, the swelling rates were all measured to be 2% or less, indicating high structural stability of the electrodes. Meanwhile, in Comparative Examples 3 and 4, since the electrodes did not satisfy the evaluation criteria during the electrode manufacturability assessment, the swelling rate evaluation was omitted.

In Comparative Examples 2, 5, 6, and 7, the swelling rates were all measured to be 15% or higher, indicating significantly reduced structural stability of the electrodes. Referring to Comparative Examples 5, 6, and 7, when both the first binder and the second binder were included as the binder and the content of the first binder was 30 wt % or less based on the total weight of the binder, structural stability of the electrode was found to be adversely affected. That is, it can be seen that the swelling rate increased as the relative content of the second binder, having strong moisture absorption, increased. Therefore, when both the first binder and the second binder are included as the binder, it was confirmed that the content of the first binder should be included at more than 30 wt % based on the total weight of the binder to prevent swelling and secure structural stability of the electrode.

The embodiments of the present disclosure have been described above with reference to the drawings. These are exemplary in nature, and the present disclosure is not limited to the embodiments and the content of the drawings described above.

It will be apparent to those skilled in the art that modifications can be made to the present disclosure within the scope of the disclosed technical idea. The described embodiments should be considered as part of the present disclosure, but the scope of the present disclosure should not be defined solely by the described embodiments.

The scope of the present disclosure should be determined by the technical idea set forth in the claims. Further, in the description of the embodiments of the present disclosure, even if actions or effects according to the configuration are not explicitly described, actions or effects that can be predicted from the described configurations should also naturally be recognized as included in the present disclosure.

What is claimed is:

1. An electrode composition for proton exchange membrane water electrolysis, the electrode composition comprising:
a binder;
a catalyst; and
a solvent,
wherein the binder comprises a polar group-free binder.

2. The electrode composition for proton exchange membrane water electrolysis according to claim 1, wherein the binder is present in an amount of greater than about 0 wt % and less than about 4.5 wt % based on the total weight of the electrode composition.

3. The electrode composition for proton exchange membrane water electrolysis according to claim 1, wherein the binder is present in an amount of about 5 wt % to 40 wt % based on the total solid content of the electrode composition.

4. The electrode composition for proton exchange membrane water electrolysis according to claim 1, wherein the binder comprises one or more of poly(1,1,2,2-tetrafluoroethylene) (PTFE), polyetheretherketone (PEEK), polyimide (PI), polybenzimidazole (PBI), or any combination thereof.

5. The electrode composition for proton exchange membrane water electrolysis according to claim 1,
wherein the solvent comprises an alcohol, and
the alcohol is present in an amount of 60 wt % to 90 wt % based on the total weight of the solvent.

6. The electrode composition for proton exchange membrane water electrolysis according to claim 1, wherein the binder further comprises a polar group-containing binder.

7. The electrode composition for proton exchange membrane water electrolysis according to claim 6, wherein, based on the total weight of the binder, the polar group-free binder is present in an amount greater than or equal to about 30 wt % and less than about 90 wt %.

8. The electrode composition for proton exchange membrane water electrolysis according to claim 6, wherein the polar group-free binder is present in an amount of greater than about 0 wt % and less than about 4.5 wt % based on the total weight of the electrode composition.

9. The electrode composition for proton exchange membrane water electrolysis according to claim 6, wherein the polar group-free binder comprises one or more of poly(1,1,2,2-tetrafluoroethylene) (PTFE), polyetheretherketone (PEEK), polyimide (PI), polybenzimidazole (PBI), or any combination thereof.

10. The electrode composition for proton exchange membrane water electrolysis according to claim 6, wherein the polar group-containing binder comprises perfluorosulfonic acid (PFSA).

11. An electrode for proton exchange membrane water electrolysis, the electrode comprising:
a binder; and
a catalyst,
wherein the binder comprises a polar group-free binder.

12. The electrode for proton exchange membrane water electrolysis according to claim 11, wherein the binder is present in an amount of about 5 wt % to 40 wt % based on the total weight of the electrode.

13. The electrode for proton exchange membrane water electrolysis according to claim 11, wherein the D10 of the binder is about 0.5 μm to 2.0 μm, the D50 is about 2.5 μm to 5 μm, and the D90 is about 20 μm to 80 μm.

14. The electrode for proton exchange membrane water electrolysis according to claim 11, wherein the binder comprises one or more of poly(1,1,2,2-tetrafluoroethylene) (PTFE), polyetheretherketone (PEEK), polyimide (PI), polybenzimidazole (PBI), or any combination thereof.

15. The electrode for proton exchange membrane water electrolysis according to claim 11, wherein the binder further comprises
a polar group-containing binder.

16. The electrode for proton exchange membrane water electrolysis according to claim 15, wherein, based on the total weight of the binder, the polar group-free binder is present in an amount of greater than or equal to about 30 wt % and less than about 90 wt %.

17. The electrode for proton exchange membrane water electrolysis according to claim 15, wherein
the polar group-free binder comprises one or more poly(1,1,2,2-tetrafluoroethylene) (PTFE), polyetheretherketone (PEEK), polyimide (PI), polybenzimidazole (PBI), or any combination thereof, and
the polar group-containing binder comprises perfluorosulfonic acid (PFSA).

18. An anode comprising the electrode composition of claim 1.

19. A membrane-electrode assembly comprising the electrode of claim 11.

20. A proton exchange membrane water electrolysis cell comprising the electrode for proton exchange membrane water of claim 11.
